(19) United States
(12) Patent Application Publication
(10) Pub. No.: US 2018/0308140 A1
(43) Pub. Date: Oct. 25, 2018

(54) System and method for real estate commissions and buyer's rebates advertising

(71) Applicant: Dmitry Shkipin, Fremont, CA (US)

(72) Inventor: Dmitry Shkipin, Fremont, CA (US)

(21) Appl. No.: 15/490,905

(22) Filed: Apr. 19, 2017

(51) Int. Cl. G06Q 30/06; G06Q 50/16; G06Q 30/02; G06Q 50/00

(52) U.S. Cl. CPC G06Q 30/0613; G06Q 50/01; G06Q 30/0255; G06Q 50/16

(57) ABSTRACT

System and method are described for autonomous matching and competitive advertisement of real estate agency commissions and buyer's rebates corresponding to real property to sellers and buyers via an online network. A matching process between real estate agencies, sellers and buyers is facilitated autonomously via network without “middle-man” referral fees. Access for one or more real estate agencies, sellers and buyers is provided via private accounts for all participants. Each real estate agency must be willing to compete for sellers and buyers representation agreements by advertising competitive list of services, commissions and, where allowed, buyer's rebates for local real estate representation.

### BACKGROUND OF THE INVENTION

### 1. Field of the Invention

The present invention relates to facilitating autonomous matching and competitive advertisement of real estate agency commissions and buyer's rebates corresponding to real property to sellers and buyers by registered real estate agencies via an online network.

Online advertising and connecting via the Internet is increasingly common. Social networks, business networks, professional communications networks and many similar services operate by offering users an economic benefit they would not otherwise are able to obtain, often for free, in exchange for advertising related services, promoting or otherwise distinguishing information with an economic value. Internet users often rely on these services to obtain economic benefits outside the Internet, such as a social network connections help users keep in touch with real life friends, professional networks help users promote their skills and advance their career in the workplace.

At the same time, online services, mostly can only offer marginal support for their users in a form of an economic benefit. Professional communications network, for example, can help its users advance their career thru connections, but it is never a substitute for real workplace interactions and references. The real life interactions, negotiations and perceptions may never be replaced by online system of any kind.

### 2. Description of the Related Art

Real estate market is a highly personal and is guided by risk aversion as much as it is guided by substantial rewards to participating parties. Transactions within real estate market, specifically residential real estate, are almost always high-value seldom events in most people's lives. Due to relatively seldom interaction with this market by sellers and buyers and high risk aversion, parties generally rely on real estate professionals to guide them thru the process. Real estate agencies, on the other hand, are common, with many agents competing for the same market. Only a small fraction of local real estate agencies enters into representation agreements consistently, mostly due to frequent referrals by past customers or paid online services that actively advertise agencies. This in itself, creates market conditions with real estate agencies having a monopoly on their representation service, knowingly competing with only few others. Evidence of such monopolistic behavior becomes obvious, for example, when a small group of real estate agencies and interests persuade State's legislature to prohibit practices of offering buyer's commissions' rebates and similar effective tools and effectively increase price of homeownership for the entire population of their constituents for the benefit of the few real estate agents. The same methodology is often applied by real estate agents to daily services they provide. Once a seller or a buyer approaches real estate agency for representation services, the question of commissions is rarely the main topic of the negotiations, almost all agents agree that a “six-percent” commission for full listing representation is standard. For the real estate agent this methodology is an easy sell in a high risk aversion process, because neither buyer nor seller wants to start their real estate transaction by “aggressive negotiations” for commissions, potentially compromising the total value of the entire transaction.

Secondly, the current model is also economically wasteful because the prices for real estate properties in the United States are generally governed by the lending policies of the Federal Reserve and mortgage institutions, rather than cash-on-hand of the parties initiating a transaction. With landing practices as the main driver of the real estate markets in the United States, the aggregate price for real estate may differ dramatically just over few years, depending on the current interest rates and willingness of mortgage institutions to make loans and/or to hold foreclosed real estate inventory off the market. Real estate agencies take advantage of this model by tying their fees for representation commissions directly to the transaction value, rather than the hourly time and effort it may take to conduct a particular transaction.

While the real estate market fluctuates rapidly, the “six-percent” commission standard is highly guarded by real estate agencies. That is not to say that there have not been some attempts to break the current commission's and buyer's rebates structure by legitimate services offering a lower commissions and rebates as part of their business model or “middle-man” brokers offering customers to negotiate a lower commissions on their behalf in exchange for a referral fee. These efforts, however, have not been successful mainly because of a lack of organized and effective service to help facilitate the effective commissions and rebates competition process and an effective financial barrier in a form of a referral fee. Currently, select “middle-man” brokers advertise to find sellers and buyers an agency that offers lower listing commissions and buyer's rebates, but while doing so, these “middle-man” brokers collect 25-50 percent of the savings for themselves, effectively discouraging sellers and buyers to use these services as an effective means for negotiations. Currently, brokers operating as “middle-men” for real estate transactions, typically enter into referral fee agreements with pre-selected agencies looking to expand their opportunities before they find a seller or buyer looking for representation. Once the seller or buyer contacts the “middle-man” broker, their information is simply forwarded to the pre-selected agency with whom the “middle-man” broker has the most advantageous agreement with. Such model is ineffective, wasteful and is almost never in the best interest of the consumer and only benefits the pre-selected agency and the “middle-man” itself.

In addition to the “middle-man” brokers' present model for encouraging competitive sellers listing commissions and buyer's rebates, few select agencies meet some of the demand for competitive representation by building their agency's business model on directly advertising lower sellers listing commissions and offering buyer's rebates. These services are instrumental in changing the “six-percent” standard commission's rate structure, but they are also at a disadvantage of having to promote themselves as potentially having to provide a sub-par service, instead of offering a competitive fees in order to compete for a larger customer base. Needless to say, neither model fully serves the parties looking for competitive and effective representation for their real estate transaction.

It is therefore desirable to provide an online service that functions without referral fees to effectively advertise participating real estate agencies, their listing commissions and buyer's rebates in a competitive environment, without prior referral fee agreements with pre-selected real estate agencies.

### SUMMARY OF THE INVENTION

According to the present invention, methods and apparatus are provided by which a real estate commissions and rebates are negotiable and are advertised as competitive among local agencies autonomously, without a need to enter into “middle-man” referral fee agreements with participating agents. According to various specific embodiments, the present invention provides a competitive OPEN marketplace for real estate commissions and rebates, prompting users to create “leads” and to forward such “leads” directly to participating real estate agencies that opt-in into the service. This service effectively replaces prevailing models of “middle-man” referral fee agreement services and allows participating real estate agencies advertise their rates in a competitive environment to sellers and buyers that are looking for overall value rather than an archaic “six-percent” commissions sales pitch.

The most effective aspect of such service is the aggregate commissions and buyer's rebates savings that come with a responsibility of homeownership. With the service in operation, the real estate agency “middle-man” referral services are no longer able to justify collecting wasteful fees for finding real estate agents willing to offer competitive commissions and rebates. Further, real estate agencies that are willing to offer competitive commissions and buyer's rebates may do so using the service regardless if their business model and unrelated advertising efforts allow to advertise lower rates.

It should be noted that while several embodiments of the invention are described herein with reference to residential real estate commissions and rebates market, the service described is also applicable to commercial real estate market commissions and rebates advertisement market. The residential real estate market is the most favorable application of the invention, simply due to a larger user base where it is most effective. Commercial real estate commissions and rebates advertisements may require adjustments in the overall service, however, without departing from the spirit or scope of the invention.

One of the core requirements for the invention and an essential requirement for the operation of the service is an active and responsive “opt-in” set of real estate agents throughout the United States. In order to be qualified as an “opt-in” real estate agent certain conditions must be met.

Before a real estate agent may “opt-in” into the service must, she must have a valid and current real estate license in the State that they choose to provide representation to real estate sellers and buyers and are able to legally and practically to do so, regardless of how each agency's business entity is structured, individual, corporation, sales associates or any other form of legal real estate representation, this is one of the requirements that may never be skipped for the service to properly operate.

Each real estate agent that “opts-in” into the service needs to create an account with either user-generated or system-generated password or credentials.

Each real estate agent that “opts-in’ into the service needs to provide basic contact information, such as name, address, phone, email, although not all items may be needed and additional information may be requested to enhance user experience, such as agency experience, years in business, online references, volume of sales, photos or headshots, and other similar information.

Each real estate agent that “opts-in” into the service needs to provide or select service areas where their representation services may be offered; agency's service areas may include neighborhoods, cities, counties, States or another form of geographical classification that may be necessary.

Each real estate agent that “opts-in” into the service needs to provide advertised commission rates for any number of pre-defined transaction price bracket ranges, agencies may have to select different scales for commission rates and there may be more than one list of pre-defined transaction price bracket ranges that an agency can pick from to better match their pricing model.

Each real estate agent that “opts-in” into the service needs to provide advertised buyer's rebates rates for any number of pre-defined transaction price bracket ranges, agencies may have to select different scales for buyer's commission rebates rates and there may be more than one list of pre-defined transaction price bracket ranges that an agency can pick from to better match their pricing model. In some States buyer's commission rebates are not allowed and therefore may not be advertised, until the specific State's law is changed.

Each real estate agent that “opts-in” into the service needs to provide advertised list of real estate representation services it offers as part of the advertised fee schedule separately for buyers and sellers. The list of services may include any number of items and there may be more than one list of pre-defined services to choose from or real estate agency may use their own list of services.

Each real estate agent that “opts-in” into the service needs to actively respond and follow-up on any legitimate incoming “leads” generated by the perspective sellers and/or buyer using the service.

It should be noted that while all of these parameters are likely to be included as part of the definition for an “opt-in” real estate agency, some of these parameters are not necessary and some additional parameters may be added for to increase convenience and ease-of-use. According to the present invention, the main distinction of the “opt-in” real estate agency is that it agrees with the terms and conditions of the service by creating an account, is legally able and capable to provide services it advertises and that it provides a reasonable fee schedule as part of the advertisement process.

The electronic “lead” generated by the service of the present invention is another core function of the service, and is the main method of delivering prospective seller's and buyer's interest to the real estate agent. The information contained within electronic “lead” has a number of different attributes.

First, the “lead” is initiated by either perspective real estate buyer or seller thru the service.

Second, the “lead” includes either and exact address in the United States or general approximate location(s) of the perspective buyer's or seller's interest to be represented in a real estate transaction to be provided thru the service.

Third, the “lead” includes either an exact budget amount or an approximate reasonable budget figure provided by the perspective real estate buyer or seller thru the service.

Fourth, the “lead” is accessible by initiating party in order to be modified, deleted, renewed or otherwise revised by the way of initiating an account with the service and establishing either user-generated or system-generated password or credentials.

Fifth, the service responsible for the operation of the system must log and store said “lead” in its database.

Sixth, the service generates a list of local real estate agents and present this list to the user that initiated the “lead” process.

Seventh, the user that initiated the “lead” approves access to any information contained in the “lead” by either sharing it with all participating local real estate agents generated by the service or selecting individual matching results to share said “lead” with. Once the perspective real estate buyer or seller shares said “lead” with real estate agent(s), the lead includes the user-defined information as well as a snap-shot of the agent's advertised terms at the moment the “lead” is shared.

Having the advertised terms be associated with the lead helps parties using the service keep better track of the terms, in case the real estate agent changes their advertisement parameters as part of normal business practice.

It should be noted that while all of these parameters are likely to be included as part of the definition of an electronic “lead,” some of these parameters are not necessary and other additional parameters may be added to increase convenience and ease-of-use. According to the present invention, the main distinction of the “lead” is that it is generated by the perspective real estate seller or buyer thru the service and is delivered directly to the real estate agency that is opt-in to the service without a requirement for any referral fee agreement between the service and the real estate agent.

According to a specific invention, the “lead” request and initiation process of the present invention provides incentive for perspective real estate sellers and buyers to begin agency representation search and negotiations by researching agency's rates before contacting them directly. Either a seller or a buyer may select several agencies that closely match their needs, using the service, knowing that each one of the “opt-in” real estate agencies was prompted to compete for their representation and to advertise the reasonable listing commission's rates or buyer commission's rebates. Further, because under present invention, the service is not a “middle-man” broker, the potential buyer and seller receive an inherit economic benefit of not having to pay referral fees, and is more likely to enter into representation agreement with an “opt-in” real estate agency, having to understand inherit savings provided by the service.

In addition, the “lead” request and initiation process of the present invention provides incentive for “opt-in” real estate agency. Real estate agencies may advertise their fees freely, without referral fees. Real estate agencies may advertise reasonable fees, without per-defined constraints set by a “middle-man” broker agreements. Real estate agencies may opt-out of the service freely, without contractual obligations imposed by “middle-man” referral fee broker agreements.

Present invention has three main characteristics that are required for its successful application. First and most of all, present invention utilizes commonly accessible Internet network that is a required element of the system. Second, present invention specifically excludes referral fees from its process lowering cost of homeownership within the United States real estate market, further provides an opportunity for said market to operate on a competitive fee scale, rather than a “standard” fee scale. Third, present invention utilizes several essential data input elements, matching algorithms, a database and a number of computing elements tied together in a specific process further described with use of drawings.

### BRIEF DESCRIPTION OF THE DRAWINGS

Referring now to the drawings in which like reference Item numbers represent corresponding parts throughout:

FIG. 01 are portions of a process flow diagram illustrating the seller's inquiry via online network platform according to overall embodiment of the invention;

FIG. 02 are portions of a process flow diagram illustrating the buyer's inquiry via online network platform according to overall embodiment of the invention;

FIG. 03 are portions of a process flow diagram illustrating the real estate agent's advertising process via online network platform according to overall embodiment of the invention;

FIG. 04 are continued portions of a process flow diagram illustrating the real estate agent's advertising process via online network platform according to overall embodiment of the invention;

FIG. 05 are continued portions of a process flow diagram illustrating the real estate agent's advertising process via online network platform according to overall embodiment of the invention;

### DETAILED DESCRIPTION OF SPECIFIC EMBODIMENTS

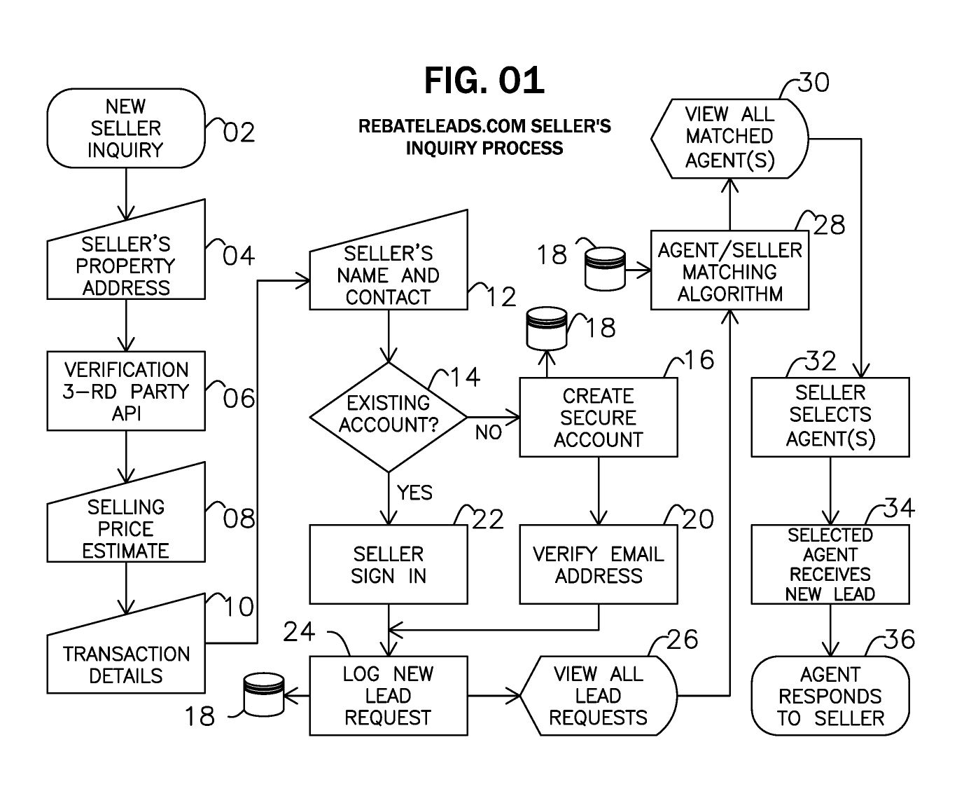

FIG. 01 Item 02 shows the seller's inquiry starting from the top level of an online platform such as a web site on a World Wide Web (www) using Hypertext Transfer Protocol (http), although other online protocols may be used for this purpose as well, providing for better security, speed, or any other advanced communications features. The seller, looking for competitive real estate representation, proceeds to the seller's gateway page, the task marked as Item 04 as a specific point of entry tailored to the seller's interest on the web site. The seller begins her inquiry by entering the property address. The property address must be entered in order to match the seller with real estate agents willing to do work within service area matching specific property address. The next task marked as Item 06 provides an opportunity for the master device responsible for operation of the service to evaluate the property address entered by the seller using either service's own database, or, most-commonly, a third-party database using an application program interface (API). This task provides an opportunity for the seller to better evaluate property's selling price estimate and confirm property details from publically and privately available sources such as GIS database, MLS database, property records, maps and similar information. The property address evaluation may be omitted, without compromising overall embodiment of the invention. Next, the seller proceeds to the task marked as Item 08 where she is required to either provide selling price estimate for the property or confirm selling price estimate for the specific property address. The selling price estimate may be referred to as any estimate, it is however never assumed to be the final selling price and is primarily used as a base for evaluating potential savings of to the advertised rates from real estate agents and to match seller with an appropriate set of agents. Once the seller enters and/or confirms the selling price estimate she proceeds to the task marked as Item 10, to enter any additional details about the selling transaction that may be helpful for the real estate agent. While this task important, it may be omitted, without compromising overall embodiment of the invention. Under the task marked as Item 12, seller proceeds to enter her personal contact information, including email address. The email address is further evaluated by the master device responsible for operation of the service the task marked as Item 14 to determine if the seller is a new user or a user with an existing account. The task marked as Item 16 provides the seller an opportunity to open a secure account and is needed to store, retrieve, organize and update “lead” details, provides an ability to send “lead” requests to real estate agents and keep track of all “lead” requests sent. The seller's account information is stored in the database of the master device responsible for operation of the service, marked as Item 18. Once the seller creates an account, the task marked as Item 20 provides an opportunity for the service to send a confirmation/welcome email with a link to verify new user's email address. While task under Item 20 is important, it may be omitted, without compromising overall embodiment of the invention. Provided that the seller already has an existing account, she will be required to sign in, the task marked as Item 22. Once the seller signs in, the seller's new “lead” request is logged, the task marked as Item 24 and is stored in the database of the master device responsible for operation of the service, marked as Item 18. Each “lead” request is assigned an individual reference number by the master device responsible for operation of the service. The seller then proceeds to view all “lead” requests that have been created under their account, the output marked as Item 26. This is an account home page for the seller, it may include new and previous selling “lead” requests, new and previous buying “lead” requests, communications with real estate agents, market statistics and any other relevant information that can help seller find real estate agency representation and real estate information related to her past and present inquiries. From the output marked as Item 26, seller proceeds by choosing desired “lead” request reference, providing an opportunity for the master device responsible for operation of the service to apply a matching algorithm, the task marked as Item 28, utilizing the data from its database, marked as Item 18. This process is essential and may not be omitted, without compromising overall embodiment of the invention. The matching algorithm compares “lead” request parameters with advertisement parameters provided by competitive local agents autonomously, without a need to enter into “middle-man” referral fee agreement with participating agents and is the essence of the invention. The algorithm itself may differ in the way it sorts and displays data, however, it requires at least the following basic set of organized variables stored in the database: agent's advertised competitive rate for a specific range of selling estimates, agent advertised services offered to sellers and seller's selling price estimate. These items may differ in description, however, core application of these elements must remain static in order to apply the algorithm successfully over time and to match real estate agents with sellers without having to rely on the referral fee agreements. Once the master device responsible for operation of the service is finished running the algorithm, the system provides seller with an output of all matched agents, marked as Item 30. The output can be organized in a diverse order, however, the core function is to provide seller with a list of matched local agents advertising competitive representation rates, where agents with more competitive rates and a better list of services are shown first. The output may include potential savings with each agent against a “standard” commission rate, ability to directly contact each agent, ability to contact each agent using master device responsible for operation of the service, list of agency services, “weighted” agent service score, ability to send a “lead” to each agent, agent information and experience, agent reviews and similar relevant information that can help seller find real estate agency representation. Once the seller is satisfied with initial output results, she proceeds by selecting specific agents, the task marked as Item 32, so that the master device responsible for operation of the service can forward “lead” request information provided by the seller to each individual agent seller specifically selected in form of a direct “lead.” Each selected agent then receives the direct “lead” the task marked as Item 34. The receipt of the “lead” may take place over email or thru an interface provided by the master device responsible for operation of the service. The task of having to receive a direct “lead” is essential and may not be omitted, without compromising overall embodiment of the invention, moreover, it provides agents an effective incentive to advertise competitive rates without having to pay a referral fees, commonly imposed by the “middle-man” brokers. This process further provides real estate agents an opportunity to list highly competitive rates using the service, without compromising agent's asking rates elsewhere, since this information can only be obtained by the seller registered with an account and is not publically published. Once the real estate agent receives a “lead” she may proceed with direct negotiations with the seller directly after responding to seller, the task marked as Item 36. The ability to contact seller directly is unique feature and is essential for overall embodiment of the invention to function, this task eliminates the need for referral fee agreements as well as limits any legal liability to the service itself with regards to seller's final real estate transaction. The task marked as Item 36 is the final results associated with the seller's inquiry; it provides the seller and the agent with a compounded benefit and is an essential element of the overall embodiment of the invention.

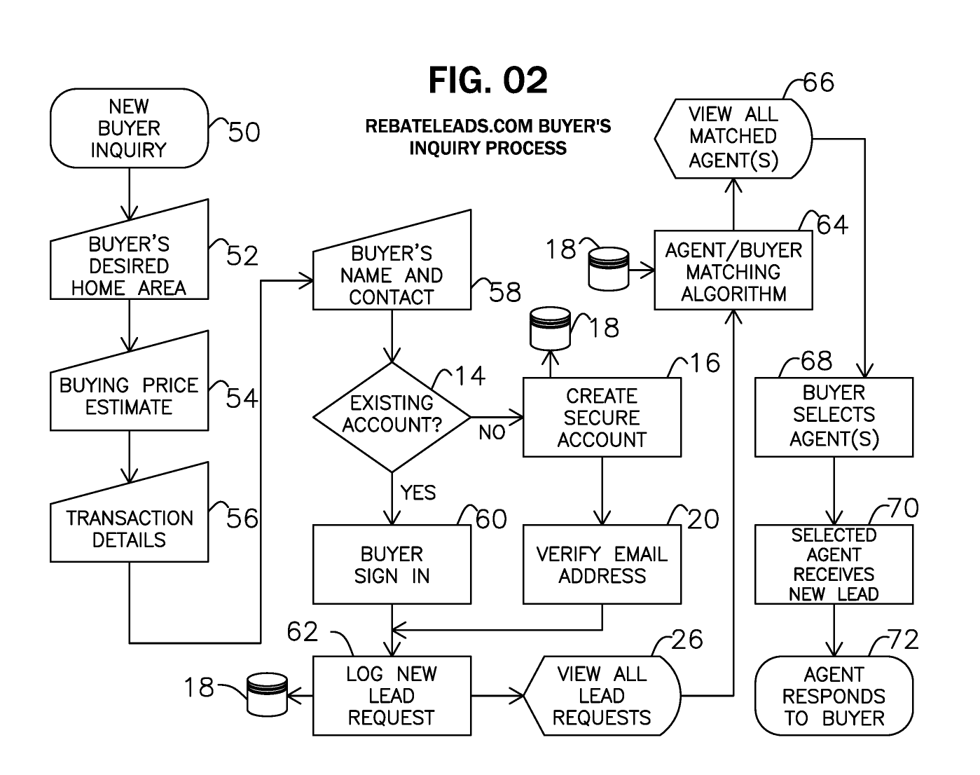

FIG. 02 Item 50 shows the buyer's inquiry starting from the top level of an online platform such as a web site on a World Wide Web (www) using Hypertext Transfer Protocol (http), although other online protocols may be used for this purpose as well, providing for better security, speed, or any other advanced communications features. The buyer, looking for competitive real estate representation, proceeds to the buyer's gateway page, the task marked as Item 52 as a specific point of entry tailored to the buyer's interest on the web site. The buyer begins her inquiry by selecting a pre-defined desired home area where she is looking to buy real estate. The desired home area designations are pre-defined by the service, most effectively using State's county as primary reference and only jurisdictions that allow buyer's rebates are shown. A more closely-defined set of areas can also be established for more dense market, such as metropolitan areas, for example a neighborhood. This task is required in order to match the buyer with real estate agents willing to do work within service area matching buyer's preference for real estate location. Next, the buyer proceeds to the task marked as Item 54 where she is required to either provide a buying price estimate that matches her purchasing budget. The buying price estimate may be referred to as any estimate, it is however never assumed to be the final buying price and is primarily used as a base for evaluating potential savings of to the advertised rates from real estate agents and to match buyer with an appropriate set of agents. Once the buyer enters and/or confirms the buying price estimate she proceeds to the task marked as Item 56, to enter any additional details about the buying transaction that may be helpful for the real estate agent. While this task important, it may be omitted, without compromising overall embodiment of the invention. Under the task marked as Item 58, buyer proceeds to enter her personal contact information, including email address. The email address is further evaluated by the master device responsible for operation of the service the task marked as Item 14 to determine if the buyer is a new user or a user with an existing account. The task marked as Item 16 provides the buyer an opportunity to open a secure account and is needed to store, retrieve, organize and update “lead” details, provides an ability to send “lead” requests to real estate agents and keep track of all “lead” requests sent. The buyer's account information is stored in the database of the master device responsible for operation of the service, marked as Item 18. Once the buyer creates an account, the task marked as Item 20 provides an opportunity for the service to send a confirmation/welcome email with a link to verify new user's email address. While task under Item 20 is important, it may be omitted, without compromising overall embodiment of the invention. Provided that the buyer already has an existing account, she will be required to sign in, the task marked as Item 60. Once the buyer signs in, the buyer's new “lead” request is logged, the task marked as Item 62 and is stored in the database of the master device responsible for operation of the service, marked as Item 18. Each “lead” request is assigned an individual reference number by the master device responsible for operation of the service. The buyer then proceeds to view all “lead” requests that have been created under their account, the output marked as Item 26. This is an account home page for the buyer, it may include new and previous selling “lead” requests, new and previous buying “lead” requests, communications with real estate agents, market statistics and any other relevant information that can help buyer find real estate agency representation and real estate information related to her past and present inquiries. From the output marked as Item 26, buyer proceeds by choosing desired “lead” request reference, providing an opportunity for the master device responsible for operation of the service to apply a matching algorithm, the task marked as Item 64, utilizing the data from its database, marked as Item 18. This process is essential and may not be omitted, without compromising overall embodiment of the invention. The matching algorithm compares “lead” request parameters with advertisement parameters provided by competitive local agents autonomously, without a need to enter into “middle-man” referral fee agreement with participating agents and is the essence of the invention. The algorithm itself may differ in the way it sorts and displays data, however, it requires at least the following basic set of organized variables stored in the database: agent's advertised rebates for a specific range of buyer's estimates, agent advertised services offered to buyers and buyer's selling price estimate. These items may differ in description, however, core application of these elements must remain static in order to apply the algorithm successfully over time and to match real estate agents with buyers without having to rely on the referral fee agreements. Once the master device responsible for operation of the service is finished running the algorithm, the system provides buyer with an output of all matched agents, marked as Item 66. The output can be organized in a diverse order, however, the core function is to provide buyer with a list of matched local agents advertising competitive representation rates, where agents with more competitive rates and a better list of services are shown first. The output may include potential rebate savings with each agent, ability to directly contact each agent, ability to contact each agent using master device responsible for operation of the service, list of agency services, “weighted” agent service score, ability to send a “lead” to each agent, agent information and experience, agent reviews and similar relevant information that can help buyer find real estate agency representation. Once the buyer is satisfied with initial output results, she proceeds by selecting specific agents, the task marked as Item 68, so that the master device responsible for operation of the service can forward “lead” request information provided by the buyer to each individual agent that buyer specifically selected in form of a direct “lead.” Each selected agent then receives the direct “lead” the task marked as Item 70. The receipt of the “lead” may take place over email or thru an interface provided by the master device responsible for operation of the service. The task of having to receive a direct “lead” is essential and may not be omitted, without compromising overall embodiment of the invention, moreover, it provides agents an effective incentive to advertise competitive rates without having to pay a referral fees, commonly imposed by the “middle-man” brokers. This process further provides real estate agents an opportunity to list highly competitive buyer's rebates using the service, without compromising agent's offered rebates elsewhere, since this information can only be obtained by the buyer registered with an account and is not publically published. Once the real estate agent receives a “lead” she may proceed with direct negotiations with the buyer directly after responding to buyer, the task marked as Item 72. The ability to contact buyer directly is unique feature and is essential for overall embodiment of the invention to function, this task eliminates the need for referral fee agreements as well as limits any legal liability to the service itself with regards to buyer's final real estate transaction. The task marked as Item 72 is the final results associated with the buyer's inquiry; it provides the buyer and the agent with a compounded benefit and is an essential element of the overall embodiment of the invention.

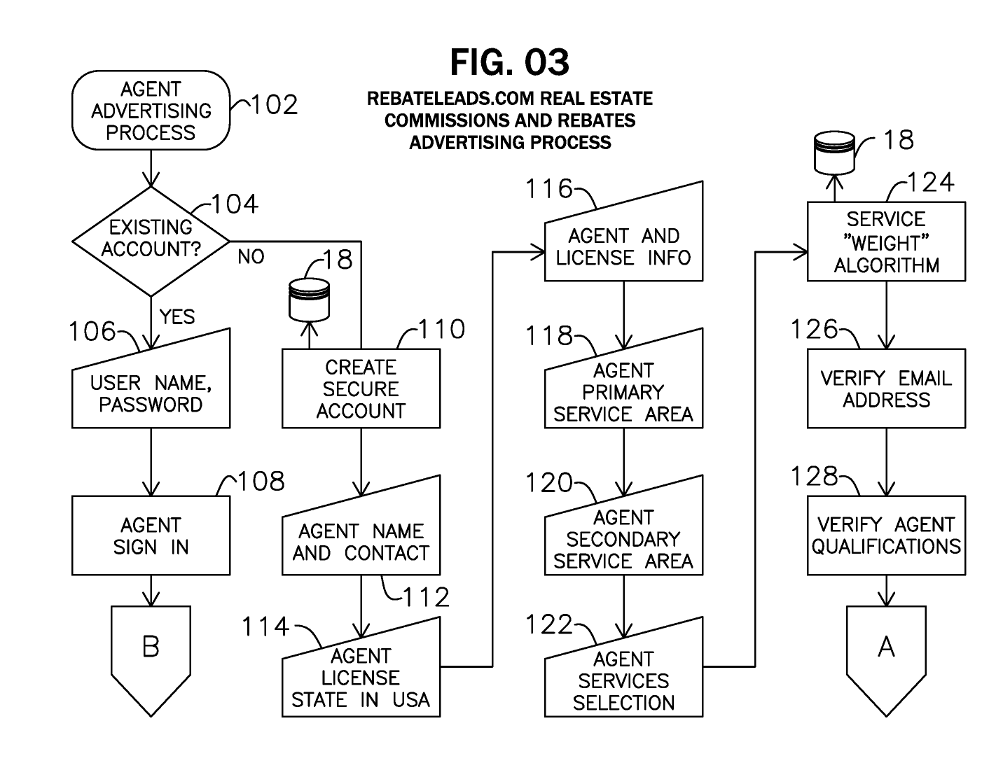

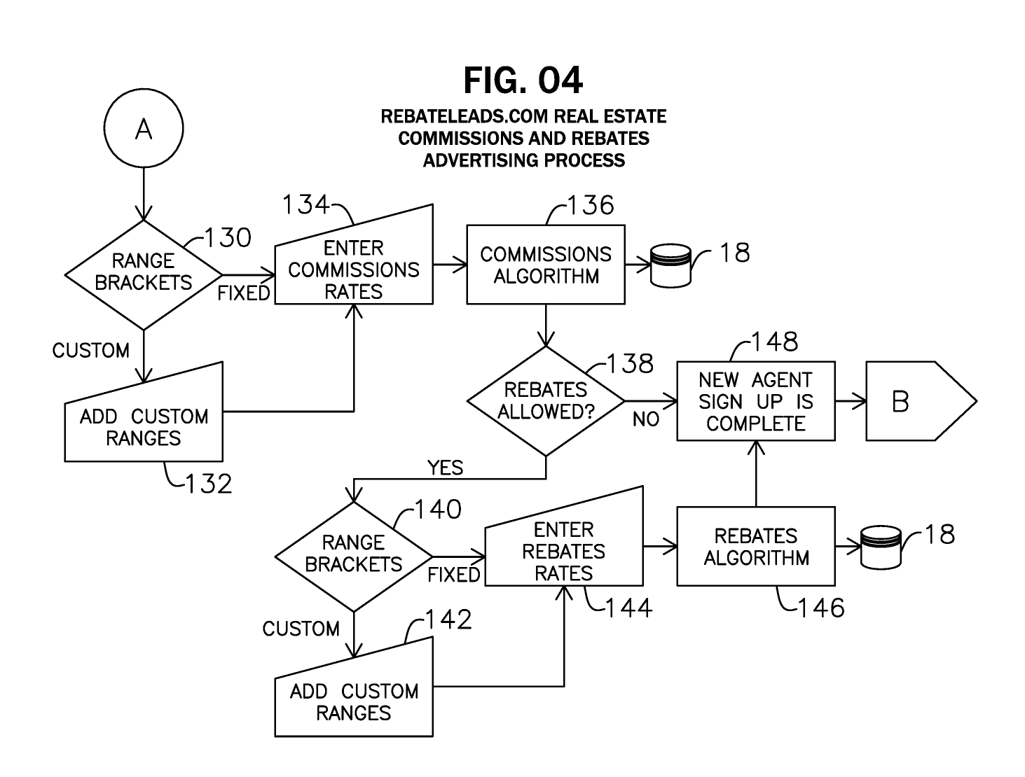

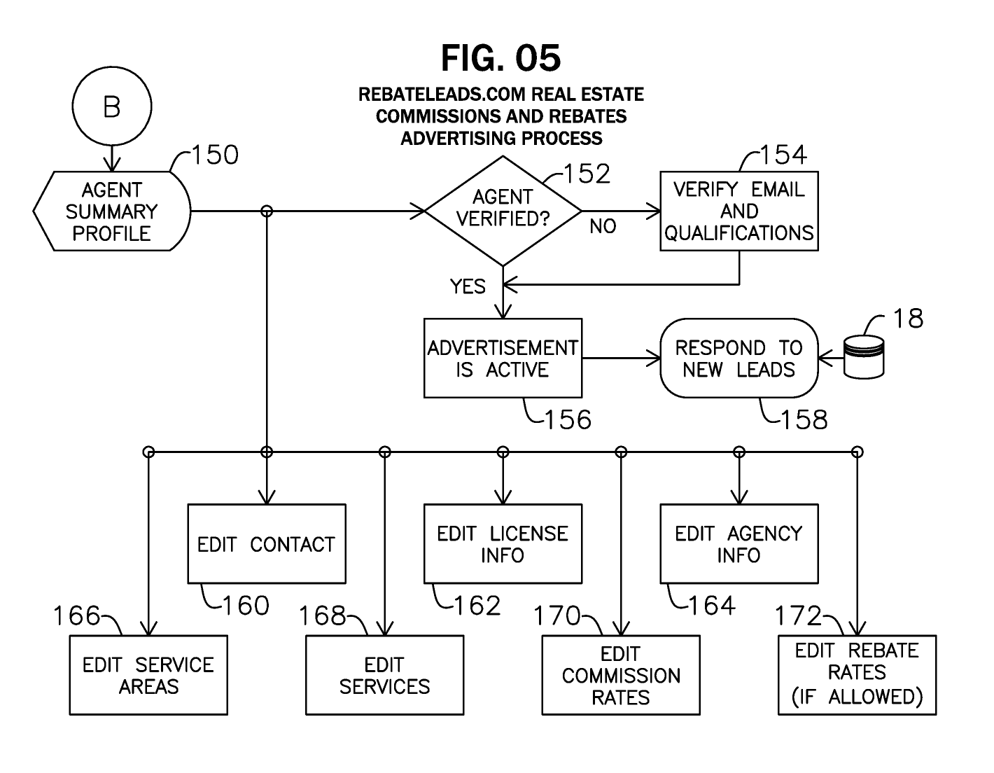

FIG. 03 Item 102 shows real estate agent's advertisement process initial point of entry starting from the top level of an online platform such as a web site on a World Wide Web (www) using Hypertext Transfer Protocol (http), although other online protocols may be used for this purpose as well, providing for better security, speed, or any other advanced communications features. The real estate agent, looking to advertise competitive representation to either sellers, buyer or both, proceeds to the real estate agent's gateway page, the task marked as Item 104 as a specific point of entry tailored to the agent's interest on the web site. All agent's information is stored under a secure account, thus the first logical task for an agent is to either log into an existing account or proceed to open a new account, the task marked as Item 104. Provided, that the agent has already signed up and has an active account, she may enter her secure user name and password, the task marked as Item 106. Next, the master device responsible for operation of the service logs the agent into the secure account, marked as Item 108, from where she may further proceed with a number of tasks, described further in the FIG. 05. However, if the agent has not yet registered with a service, she is required to create a secure account, marked as Item 110, and this new information is stored in the database of the master device responsible for operation of the service, marked as Item 18. The agent's registration is a required task of the process, and is essential for overall embodiment of the invention to function. Within present invention, real estate agents are not required to sign a referral fee agreement as part of the registration, but are required to agree and abide by the service's terms of use and privacy policy and most importantly, only agree to advertise reasonable services, rates and rebates. Next task, marked as Item 112, provides an opportunity for the real estate agent to provide name and contact information. This information is essential for overall embodiment of the invention to function and may not be omitted. The reason for this is that the service responsible for the operation of the system, must have an adequately complete and accurate roster of all agents that have registered with an account in order to provide the correct and comprehensive list of matched agents to sellers and buyers. The next task, marked as Item 114, provides an agent an opportunity to enter a specific State within United States that she has an active and current license to practice real estate representation services. This task is essential for overall embodiment of the invention to function and may not be omitted because it provides the service an ability to assign jurisdiction limitations rules of each specific state, in particular, real estate agent's ability to provide buyer's rebates for her clients. Despite the proven fact that real estate buyer's rebates greatly benefit consumers, many States do not allow such rebates due to heavy lobbying by the real estate professional interests, and conversely pass laws outlawing buyer's rebates that do not benefit consumers. Some local State jurisdictions, despite objections by the United States Department of Justice, continue to limit an ability for competitive advertisement practices and such laws must be taken into account according to the overall embodiment of the present invention. States that do not allows buyer's rebates, until the law is expressively changed, are excluded from the buyer's rebates advertisement process according to the overall embodiment of the present invention. Next, the task marked as Item 116, further provides the real estate agent an opportunity to provide details about her Board of Real Estate license qualifications, such as the type of license issued, license number, license status, year license was first issued and any other relevant information that may help establish real estate agent's credibility with sellers and buyers. This information is highly important, and may not be omitted without compromising overall embodiment of the invention. Next, the task marked as Item 118, the real estate agent selects a primary service area where she can practically offer buyer's and seller's representation services from pre-defined service area selections provided by the service. This task is essential for, and may not be omitted without compromising overall embodiment of the invention. The primary service area designations are pre-defined by the service, most effectively using State's county as primary reference with all available jurisdictions within United States. A more closely-defined set of areas can also be established for more dense market, such as metropolitan areas, for example a neighborhood. This task is required in order to match the real estate agent willing to do work with seller's and buyer's preference for real estate transaction location. Further, task marked as an Item 120, provide the real estate agent an ability to enter the secondary service area under the same pretense as the primary service area. The distinction between primary service area, marked as Item 118, and secondary service area, marked as Item 120, is minimal, but it provides a service responsibly for the operation of the system to distinguish between agent's ability to provide services locally, establish a premium profile options for agents with larger service areas, and allow agents compete both, locally and State-wide with full use of State's license to practice real estate representation. The task marked as Item 120 in not essential and may be omitted without compromising overall embodiment of the invention. Next, the task marked as Item 122, allows the real estate agent to provide a list of services she offers as part of the advertised rates to sellers and buyers, separately. The information provided in this task gives sellers and buyers a better understanding of the real estate agent's advertisements and provides the service responsible for the operation of the system and ability to assign a service “weight” factor for each agent's advertisements that may be included within agent's matching algorithm with sellers and buyers. The next task, marked as Item 124, does exactly that via an application of a service “weight” algorithm by combining service sections made by the real estate agent and assigning each service an “weight” number based on the amount of time and effort it takes to produce, for example, the service designated to provide a spare key to new buyer is naturally “weighted” less against more time and effort consuming service such as to provide viewing of the perspective property. The services selected by the real estate agent, the task marked as Item 122, are compiled by an algorithm, the task marked as Item 124, and are stored in the database, task marked as Item 18. Two tasks marked as Item 122 and Item 124 are highly important, but are not essential and may be omitted without compromising overall embodiment of the invention, in such case however under present invention, each real estate agent must accept a standard list of representation services to advertise by the service responsible for operation of the system, or alternatively provide own list of services in order to have a complete representation advertisement for sellers and buyer. Next, task marked as Item 126 provides an opportunity for the service responsible for operation of the system to verify real estate agent's email address, as primary form of communicating “leads” and service maintenance messages, having the correct email address for the real estate agent is essential for, and may not be omitted without compromising overall embodiment of the invention. Next, the task marked as Item 128 provides an opportunity for the service responsible for operation of the system to verify real estate agent's qualifications and to provide an extra layer of reliability for sellers and buyers by checking to make sure the real estate agent is advertising reasonable discounts. For example, a discount of 99% from Agent's normally-asking rates is be deemed unreasonable by most people, and the service responsible for operation of the system needs the process to allow an opportunity to red-flag this advertisement with pre-established steps necessary. The task marked as Item 128 is the gate-keeper of reasonably-reliable database information and may not be omitted without compromising overall embodiment of the invention. The system or person performing the task marked as Item 128 may utilize any number of methods, independently or in any combination of, to filter unreliable data and false advertisements, including, but not limited to peer review, staff review by the service responsible for operation of the system, user reviews, user feedback, user communications of any kind, user “star” ratings, and third-party database sources. Once the real estate agent completes the entry of the basic account information, including name, contact details, license info, service areas, list of services and any other relevant data, she is further directed to the “core” of the system and the present invention, the opportunity to advertise competitive commission rates and rebates, further described in FIG. 04.

FIG. 04 Item 130 marked is an initial step that provides an opportunity for the real estate agent to advertise her competitive seller's commissions rates using the platform provided by service responsible for operation of the system. Each seller is prompted to enter a selling price estimate, task marked as Item 08 on FIG. 01. The selling price estimate entered by the seller is further matched by the service with a specific real estate agent's USD bracket ranges, each with individually-assigned commission percentage rates. Task marked as Item 130 gives the real estate agent an opportunity to choose if she would like to enter her advertised rates using fixed USD bracket ranges provided by the service or enter her own USD bracket ranges concurrent with her own real estate commission rates pricing strategy. If the real estate agent selects to use custom USD bracket ranges, the task marked as Item 132 allows the real estate agent to provide this information to the service. Once the real estate agent enters the first range, it must have advertised selling commission rate assigned to it. The real estate agent may “opt-out” from a specific USD bracket ranges by entering 0% advertised selling commission rate. For example, if the real estate agent only prefers to advertise competitive selling commissions for properties with a selling price estimate between 1 million and 2 million USD, but not for any properties with a selling price estimate below 500,000 USD, she would be required to provide at least two USD bracket ranges: 0 thru 500,000 USD at 0% selling commission rate and 1 million thru 2 million USD at any competitive and reasonable selling commission rate she chooses to advertise her services at in the task marked as Item 134. Provided, that the real estate agent wants to take a simpler approach to advertising her rates, she may simply enter her advertised selling commission rates in the task marked as Item 134 based on fixed most-commonly used USD bracket ranges provided by the service. The task marked as Item 134 can have two commission rates assigned, first is a “split commission rate” that is used to advertise selling commission rate if commission is split between seller's and buyer's agent; second, “no split commission rate” that is used to advertise selling commission rate if the buyer is not represented her own buyer's agent. The difference between “split” “no split” rates is essential to be noted because in the event that the buyer is not represented by her own buyer's agent, seller's agent will normally keep the full commission amount and, therefore, can advertise lower rates for the event seller's commission is not split with buyer's agent. The real estate agent does not have to take advantage of this difference and can list the same advertised selling commission rate regardless of the “split” with buyer's agent. The seller has an opportunity to view both figures in the task Item 30 on FIG. 01 and decide how to proceed based on her personal preference. Since there is no way to determine if the seller will accept in the future an offer presented by the buyer with her own buyer's agent or buyer who is not represented by a buyer's agent, both “split” and “no split” advertised seller's commission rates and potential savings are presented to the seller in task marked as Item 30 on FIG. 01. “Split commission rate” and “no split commission rate” advertisement figures difference provides an incentive for the real estate agent to provide overall lower rates to sellers, is essential for, and may not be omitted without compromising overall embodiment of the invention. Next, task marked as Item 136, allows the service responsible for operation of the system to run commissions algorithm and update the database, marked as Item 18, with new information with real estate agent's seller's commission rates. The next task, marked as Item 138, is an evaluation performed by the service responsible for operation of the system to automatically determine if the buyer's rebates are allowed in the State jurisdiction the real estate agent has a license to provide services. The list of States that currently allow buyer's rebate must be continuously updated by the service in order to update information about the States that change their legislature. If the State jurisdiction does not currently provide its constituents with a competitive advantage by allowing a legal mechanism for processing buyer's rebates, the real estate agent sign-up process is finalized by the service, task marked as Item 148, and the real estate agent further directed to agent summary profile, task marked as Item 150 on FIG. 05. If the service determines that the real estate agent can provide buyers whom they represent buyer's rebates, the real estate agent further proceeds to the task marked as Item 140 to determine if she would like to either use USD bracket ranges for rebate advertised rates as fixed or custom.

Each buyer is prompted to enter a buying price estimate, task marked as Item 54 on FIG. 02. The buying price estimate entered by the buyer is further matched by the service with a specific real estate agent's USD bracket ranges for rebates, each with individually-assigned buyer's rebate percentage rates. Task marked as Item 140 gives the real estate agent an opportunity to choose if she would like to enter her advertised rebates using fixed USD bracket ranges provided by the service or enter her own USD bracket ranges concurrent with her own real estate buyer's rebate pricing strategy. If the real estate agent selects to use custom USD bracket ranges, the task marked as Item 142 allows the real estate agent to provide this information to the service. Once the real estate agent enters the first range, it must have advertised rebate rate assigned to it. The real estate agent may “opt-out” from a specific USD bracket ranges by entering 0% advertised rebate. For example, if the real estate agent only prefers to advertise competitive rebates for buyer's with a buying price estimate between 1 million and 2 million USD, but not for any buyers with a buying price estimate below 500,000 USD, she would be required to provide at least two USD bracket ranges: 0 thru 500,000 USD at 0% rebate and 1 million thru 2 million USD at any competitive and reasonable buyer's rebate she chooses to advertise her services at in the task marked as Item 144. Provided, that the real estate agent wants to take a simpler approach to advertising rebates, she may simply enter her advertised buyer's rebates in the task marked as Item 144 based on fixed most-commonly used USD bracket ranges provided by the service. Since buyer's rebates can only function with real estate transactions where seller is always represented by a real estate agent, there is no “split” and “no split” difference for application of buyer rebates, and only one rebate percentage is required for each individual USD bracket range. Next, task marked as Item 146, allows the service responsible for operation of the system to run rebates algorithm and update the database, marked as Item 18, with new information with real estate agent's rebates. Next, the real estate agent sign-up process is finalized by the service, task marked as Item 148, and the real estate agent further directed to agent summary profile, task marked as Item 150 on FIG. 05. The process and method of providing the service responsible for operation of the system with competitive advertised real estate seller's commission rates and buyer's rebates described in FIG. 03 and FIG. 04 is essential and is the “core” of the system and the present invention. The process and tasks, described in FIG. 03 and FIG. 04 provides for an opportunity for sellers and buyers to evaluate real estate agent's pricing before deciding to send or not to send a new “lead” and prompts real estate agents to list competitive rates in order to have a higher chance of receiving a “lead.”

FIG. 05 The task, marked as Item 150, provides an opportunity for the registered real estate agent to attend to her profile, make info changes, ask the service to re-send verification email, contact the service about any issues, edit service areas, edit list of services, edit seller's commission rates, edit buyer's rebates where State jurisdiction allows, activate or deactivate advertising, check how adverting is displayed by the service responsible for operation of the system to sellers and buyers, and most importantly to the real estate agent herself, an ability to view and respond to new “leads.” The real estate agent's summary page may be references in any form and have additional functions, and may not be omitted without compromising overall embodiment of the invention. First, the agent summary page allows the real estate agent to confirm the status of her advertisement. The agent proceeds to the task marked as Item 152. If the real estate agent has already verified the emails address in the task marked as Item 126 on FIG. 03 and has been either approved or not disqualified by the service responsible for operation of the system, then the real estate agent's advertisement is fully activated as shown in the task marked as Item 156. Once the real estate agent's advertisement is active, her advertisements are matched with seller's and buyer's “lead” requests and further, once the seller in the task marked as Item 32 on FIG. 01 or a buyer in the task marked as Item 68 on FIG. 02 selects to contact the real estate agent, the real estate agent may respond to the “lead” directly as a task marked as Item 158 after the service responsible for operation of the system retrieves new “leads” information from its database, marked as Item 18. However, if the real estate agent is not verified as necessary by the service, she should first proceed to do so, the task marked as Item 154, otherwise the real estate agent's advertisement will remain inactive. Agent summary profile, marked as an Item 150, allows a number of functions to edit, update, modify and add the information the real estate agent was asked to provide during the sign-up process. First, the real estate agent may edit and update her contact information, marked as Item 160. Second, the real estate agent may edit and update her license information, marked as Item 162. Third, the real estate agent may edit and update her agency information, marked as Item 164. Fourth, the real estate agent may edit and update her service areas information, marked as Item 166. Fifth, the real estate agent may edit and update her list of services for sellers and buyers, marked as Item 168. Sixth, the real estate agent may edit and update her advertised seller's commission rates, marked as Item 170. Seventh, the real estate agent may edit and update her advertised buyer's rebates rates whenever allows by the local jurisdiction, marked as Item 172. FIG. 05 lists “core” nodes required for a complete and functioning profile for the real estate agent, however, some of the items listed on FIG. 05 may be omitted as needed or modified, while others can be added to support additional information needed to provide the best and most comprehensive advertisement possible for sellers and buyers of the real estate across the United States. FIG. 05 provides a comprehensive review for the real estate agent as well as an opens an ability for flexible and effective competitive behavior among real estate agents across the United States within local real estate markets. The service responsible for operation of the system undeniably relies on the active participation of the real estate agents within local real estate markets to properly operate. The process, further, does not require a “middle-man” to match sellers and buyers with agents by means of a referral fee agreement and consequently “saving” the real estate market by helping to eliminate wasteful real estate commission referral fee spending by sellers and buyers. The process, further, lowers the cost of homeownership to individuals choosing to use the service responsible for operation of the system and consequently lowering and/or removing unnecessary costs for the entire real estate market and it's consumers across the United States.

1. A computer-implemented method for facilitating a competitive advertisement of real estate agency representation to sellers and buyers via a network. Final output of the process is a complete and comprehensive electronic “lead” that may be sent and/or received by participating parties directly in order to open further real estate representation negotiations.
An online advertising relating to the real estate seller's listing commissions and buyer's commission rebates between real estate agency presented to seller or buyer in an online list of similar advertisements from competing real estate agencies in the local area; said advertisements are listed with an intent to encourage the perspective seller or buyer to send a “lead” request in response to competitive advertisements listed by each individual agency facilitated via the computer-implemented network consisting of at least three devices, at least one of which is a master device responsible for operation of the service including either a personal desktop computer, a laptop, a server, a cloud of multiple computers, a personal phone device, a mobile pad, or any other internet-capable device(s) with a relatively secure access to the Internet.
Format and process of the initial user input and matching computations made by the master device operating the service, autonomously and automatically providing an economic benefit to either seller or buyer thru display and an ability to freely respond to a set of advertisement offers presented by multiple real estate agencies knowingly competing with other agencies in the local area for the best combination of commissions, rebates and representation services in an effort to increase customer base.
Format and process of the initial user input and matching computations made by the master device operating the service, autonomously and automatically providing an economic benefit to real estate agencies by promoting their service and generating leads without burden of a referral fees agreement conducted thru the service. Referral fees are typically collected by “middle-man” registered real estate brokers who charge real estate agencies thru a prior agreement for the service of delivering information about a potential seller or buyer opportunity that results in a fully completed and executed transaction between the real estate agent and referred seller or buyer.

2. The method of claim 1 wherein providing “opt-in” access to the service for the perspective real estate seller and requesting, storing and processing information including seller's budget, seller's property address, seller's contact information and basic transaction details, and a either automatically assigned or user-defined password via either a personal desktop computer, a laptop, a server, a cloud of multiple computers, a personal phone device, a mobile pad, or any other internet-capable device(s) with a relatively secure access to the Internet.

3. The method of claim 1 wherein providing “opt-in” access to the service for the perspective real estate buyer by and requesting, storing and processing information including buyer's budget, buyer's desired property location, buyer's contact information and basic transaction details, and a either automatically assigned or user-defined password via either a personal desktop computer, a laptop, a server, a cloud of multiple computers, a personal phone device, a mobile pad, or any other internet-capable device(s) with a relatively secure access to the Internet.

4. The method of claim 1 wherein providing “opt-in” access for the service to the real estate agents registered thru appropriate Real Estate Board(s) in each State(s) jurisdiction(s) within United States and requesting, storing and processing information including agency name, agency contact information, agency license information, agency description, agency service area(s), agency seller's listing commission rates for specific transaction amount ranges, agency buyer's commission rebates for specific transaction amount ranges, and a either automatically assigned or user-defined password via either a personal desktop computer, a laptop, a server, a cloud of multiple computers, a personal phone device, a mobile pad, or any other internet-capable device(s) with a relatively secure access to the Internet.

5. The method of claim 1 further comprising providing access to real estate seller or buyer to create a real estate transaction representation interest “lead” and to share said “lead” with local real estate agencies that “opt-in” into the service via either a personal desktop computer, a laptop, a server, a cloud of multiple computers, a personal phone device, a mobile pad, or any other internet-capable device with a relatively secure access to the Internet.

6. The method of claim 1 further comprising providing access to real estate seller or buyer generated and consequently shared “leads” accessible by real estate agencies that “opt-in” into the service via the network without prior referral fee agreement between the service and the registered real estate agency that opt-in into the service via either a personal desktop computer, a laptop, a server, a cloud of multiple computers, a personal phone device, a mobile pad, or any other internet-capable device(s) with a relatively secure access to the Internet.

7. The method of claim 1 further comprising providing registered real estate agency to “opt-in” into the service to advertise reasonable and true real estate listing commission rates by requesting, storing and processing a specific advertised commission rate percentage and/or a minimum figure for any number of possible real estate transaction price ranges via either a personal desktop computer, a laptop, a server, a cloud of multiple computers, a personal phone device, a mobile pad, or any other internet-capable device(s) with a relatively secure access to the Internet.

8. The method of claim 1 further comprising of registered real estate agencies operating in selected State jurisdictions of the United States that encourage competitive and effective real estate transactions for its constituents by specifically allowing practice of advertising and payment of real estate buyer's rebates. Further comprising of such real estate agencies to “opt-in” into the service to advertise reasonable and true real estate buyer's commission rebates rates by requesting, storing and processing a specific advertised commission rebate percentage and/or a maximum figure to be paid to the buyer upon completion of the real estate transaction for any number of possible real estate transaction price ranges via either a personal desktop computer, a laptop, a server, a cloud of multiple computers, a personal phone device, a mobile pad, or any other internet-capable device(s) with a relatively secure access to the Internet.

9. The method of claim 1 further comprises a series of interfaces relating to a requesting, storing and processing information about service areas in which the real estate agency operates.

10. The method of claim 1 further comprises a series of interfaces relating to a requesting, storing and processing communications thru selection of desired advertised real estate agencies and generation of electronic “leads” by real estate sellers and buyers using the service, further providing an economic benefit to the real estate sellers and buyers by providing them with competitive advertisement rates and list of services from real estate agencies and an ability to contact these agencies without a burden of referral fees.

11. The method of claim 1 further comprises a series of interfaces relating to a requesting, storing and processing communications by real estate agencies receiving and responding to “leads” generated by the sellers and buyers, further providing an economic benefit to the real estate agencies by expanding their business opportunities and an ability to contact perspective sellers and buyers without a burden of referral fees.
